(19) United States
(12) Patent Application Publication
(10) Pub. No.: US 2017/0361472 A1
(43) Pub. Date: Dec. 21, 2017

(54) Robot Cell

(71) Applicant: Comau S.p.A., Grugliasco (Torino) (IT)

(72) Inventors: Michele De Padova, Grugliasco (Torino) (IT); Gianluca Gastaldi, Grugliasco (Torino) (IT)

(21) Appl. No.: 15/621,176

(22) Filed: Jun. 13, 2017

(30) Foreign Application Priority Data
Jun. 16, 2016 (IT) 102016000062145

(51) Int. Cl. B25J 21/00; G09B 19/00; B25J 19/00; A47B 97/00; A47B 96/20; A47B 81/00; A47B 51/00; A47B 46/00; A47B 21/03; G09B 25/02; A47B 88/988

(52) U.S. Cl. CPC B25J 21/00; G09B 25/02; G09B 19/00; B25J 19/0075; A47B 97/00; A47B 88/988; A47B 81/00; A47B 51/00; A47B 46/00; A47B 21/0314; A47B 96/20

(57) ABSTRACT

A robot cell useful for robot demonstrations. The robot cell includes a base frame having an outer casing and a working surface having a through opening. A multi-axis demonstration robot is mounted to a stand within the base and may selectively be raised through the through opening to a demonstration position above the working surface or a storage position below the working surface and concealed within the base frame outer casing. A protective screen is positioned outside the working surface and base frame and is selectively raised and lowered to respectively surround the working surface and robot during demonstrations and lowered around the base frame during non-use. The base may include one or more retractable drawers for storage of cell control units or a robot controller. When in a storage or non-demonstration position, the cell is transportable and compact taking a minimum amount of space.

### TECHNICAL FIELD

The present invention relates to a robot cell for demonstration purposes.

The cell includes a work centre, which, however, is not designed for use in an actual production process, but rather for use in activities of a purely demonstration nature. The cell may, for example, be used in sector fairs, in training operators, or else even in schools for exclusively didactic purposes.

### BACKGROUND

In the specific field of industrial robots, cells of this type have appeared only with the spread, also in the industrial field, of smaller-sized manipulator robots. These robots usually have a maximum carrying capacity, at the wrist, of a few kilograms, and maximum dimensions, in height and length, of around one metre. The robots in question are commonly used for carrying out an extremely wide range of operations, in the framework of any industrial process, or as replacement for the operator or else in co-operation with, or support to, the operator.

In the light of what has been said above, it is clear that the normal use of a robot cell of the type in question is substantially different from that of a traditional work centre, envisaging, in particular, frequent displacements for reaching the various exhibition centres, which may be, as has been seen, industrial plants, schools, sector fairs, etc.

To facilitate transport and displacements, already today cells of this type have their own base mounted on swivel wheels so as to be displaceable and manoeuvrable.

### SUMMARY

The object of the present invention is to provide a robot cell that will be improved as compared to the known cells, and in particular that will afford a series of advantages as regards the operations of transport and storage when not in use.

The object referred to is achieved via a robot cell comprising the characteristics specified in Claim 1.

A further object of the present invention is to provide a work cell that has a particularly functional and flexible configuration, in the perspective of a use of the cell for multiple applications.

### BRIEF DESCRIPTION OF THE DRAWINGS

Further characteristics and advantages of the invention will emerge from the ensuing description with reference to the annexed drawings, which are provided purely by way of non-limiting example and in which:

FIG. 1 is a perspective view of the robot cell described herein according to a possible embodiment, the cell being represented in an operative configuration thereof;

FIG. 2 illustrates the work cell of FIG. 1, in a compact configuration thereof;

FIG. 3 is a front view of the cell represented in FIG. 2, where some parts of the base of the cell have been removed in order to illustrate how the robot sets itself inside the base in the compact configuration assumed by the cell;

FIGS. 4A and 4B are, respectively, a front view and a lateral view of the robot cell illustrated in FIG. 1, where also in this case some parts of the base of the cell have been removed to show the systems of movement of the robot and of the protective screen, which will be illustrated in detail in what follows; and

FIG. 5 is a schematic representation of the systems for movement of the robot and of the protective screen provided in the cell of FIG. 1.

In the ensuing description various specific details are illustrated aimed at providing an in-depth understanding of the embodiments. The embodiments may be obtained without one or more of the specific details, or with other methods, components, or materials, etc. In other cases, known structures, materials, or operations are not illustrated or described in detail so that various aspects of the embodiment will not be obscured.

The references used herein are provided merely for convenience and hence do not define the sphere of protection or the scope of the embodiments.

As has been seen above, the robot cell described herein constitutes a work centre for demonstration purposes. Illustrated in the figures is a preferred embodiment of the cell described herein.

In a way in itself known, the robot cell described herein, designated as a whole in the figures by the reference number 10, comprises:

a robot 20;
a base 40, which carries the robot 20 and defines a working surface P, where the robot operates; and
a protective screen 50, configured for separating from outside the working surface P and the robot operating on the aforesaid surface.

The robot 20 is a small-sized industrial manipulator robot. In the example illustrated, the robot is represented by the robot that is marketed by the present applicant under the brand name RACER 3®.

The cell described herein is characterized in that it is able to assume a configuration of minimum encumbrance, which has been specifically envisaged for transport of the cell and/or for storage thereof, for example in a warehouse, waiting to be used again. This configuration affords evident advantages, in particular, in terms of ease of transport, space saving, and reduction of the costs of transport and storage. Moreover, as will become evident in what follows, this configuration also enables integrity of the cell to be safeguarded during transport.

The cell is able to assume the configuration of minimum encumbrance referred to above, thanks to the following characteristics:
the robot 20 is carried by a vertical-movement system and is vertically mobile between a raised position, in which it can operate on the working surface P, and a lowered position, in which it is set underneath the aforesaid surface and is contained within the base 40; and
the protective screen 50 is supported by a vertical-movement system and is vertically mobile between a raised, operative, position, in which it separates the working surface P and the robot 20 that operates on the aforesaid surface from outside, and a lowered position, in which it extends prevalently underneath the working surface P.

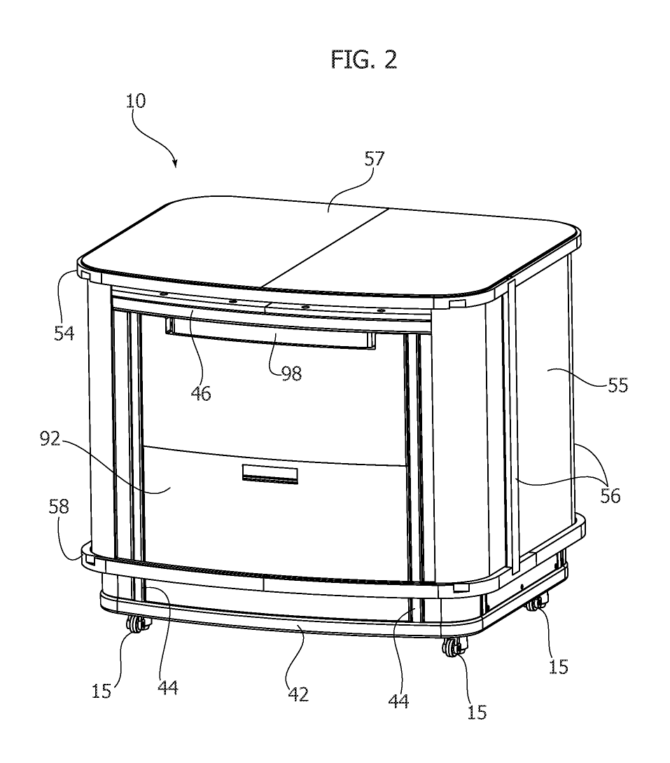

As regards the aforesaid characteristics, the configuration of minimum encumbrance referred to above is assumed by the cell when the robot and the protective screen are brought into the respective lowered position, as illustrated in FIG. 2. Since the screen 50 is able to slide out of the base 40, in its lowered position it is set around the base 40, thus enclosing it.

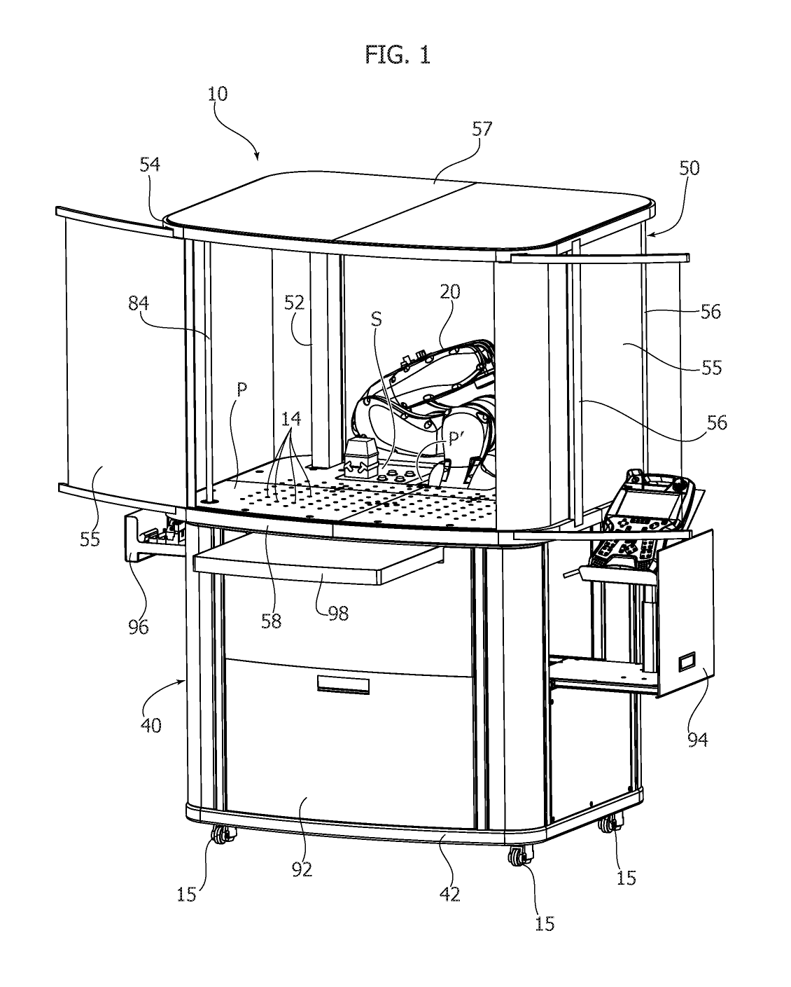

A normal operative configuration of the cell 10 is, instead, illustrated in FIG. 1. In this condition, the robot 20 and the protective screen 50 are each in the respective raised position.

It should be noted that the cell may envisage one and the same system for movement of the robot 20 and of the screen 50, or else two independent systems as in the embodiment that will be illustrated hereinafter.

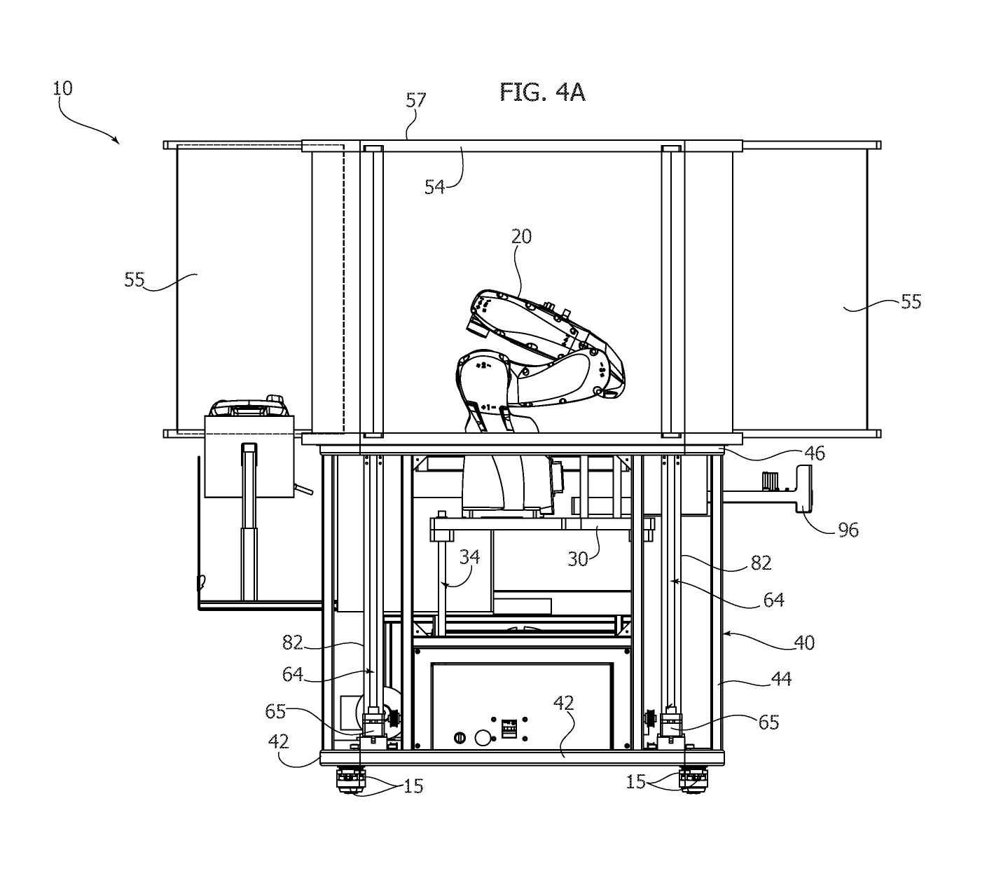

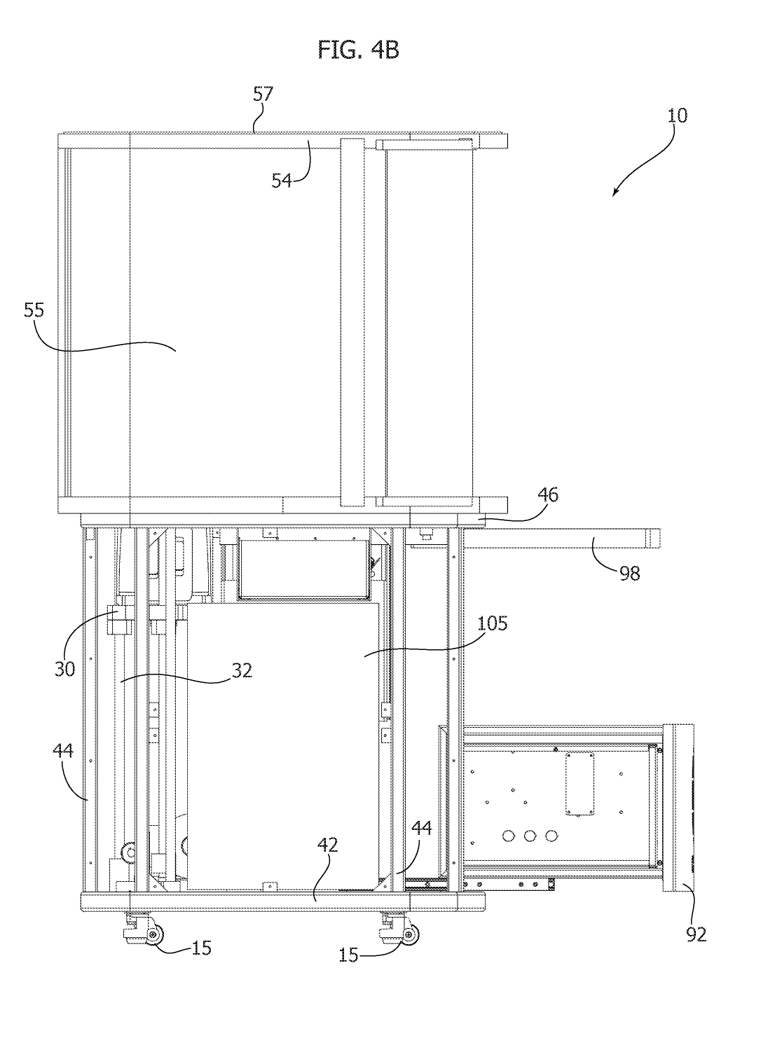

To come now to the detail of the various characteristics of the cell, in various embodiments, as in the one illustrated (see FIG. 4), the base 40 is formed by a mount comprising a bottom frame 42, a plurality of vertical uprights 44, and a top frame 46.

Mounted on the base frame 42 are one or more supporting plates that carry the driving assemblies that will be described in what follows. Mounted on the underside of the aforesaid plates are, instead, a series of swivel wheels 15.

The top frame 46 carries at the top one or more plates 48, which together define the aforementioned working surface P. Moreover carried on the same frame are a series of supporting plates (not visible), similar to the ones carried by the base frame 42, which are arranged underneath the working surface P.

In various preferred embodiments, as in the one illustrated, the working surface P has an array of threaded holes 14 for fast fixing on the aforesaid surface of possible accessories or devices with which the robot 20 is designed to operate. Moreover provided on the aforesaid surface are a series of connectors S for providing the supplies necessary for said accessories or devices, such as electric-power supply or compressed-air supply.

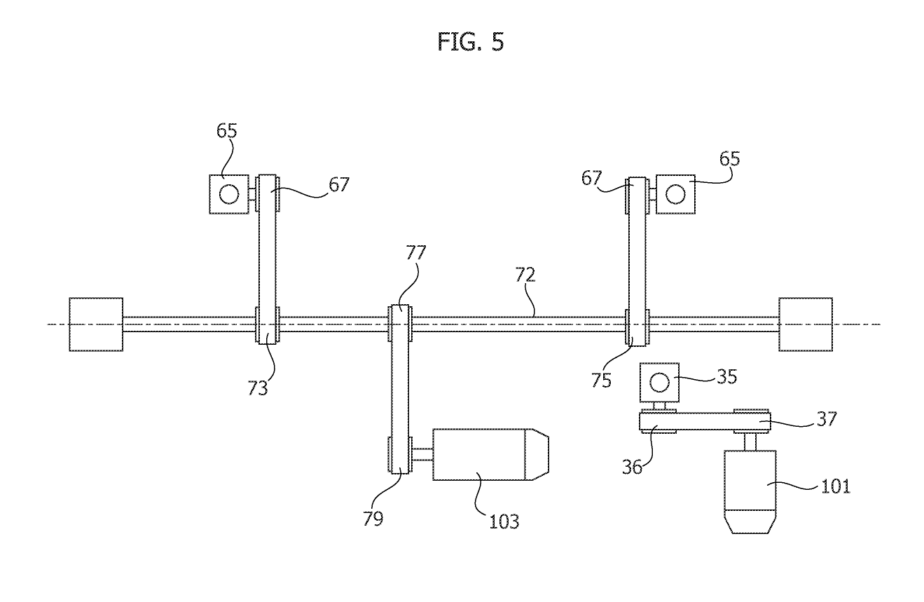

The robot 20 is mounted on a stand 30 carried by a series of cylindrical guides 32 and by a jack 34 of a rotating-screw type. The internal-screw member is fixedly constrained to the stand 30, whereas the external-screw member is constrained between the supporting plates of the two frames, the bottom or base frame 42 and the top frame 46. At the bottom the external-screw member terminates within a block 35 for transmission of motion, which is fixed on a plate of the base frame 42. In various embodiments, as in the one illustrated (see in particular FIG. 5), this block 35 has, on the output shaft, a pulley 36 that is connected via a belt to a pulley 37 fitted on the output shaft of an electric motor 101, which is also carried by a plate of the base frame 42.

With reference to the cylindrical guides 32, their respective guide bushings are directly associated to the stand 30, whereas the cylindrical guide bars are fixed, at the bottom and at the top, to the plates of the frames 42 and 46, respectively.

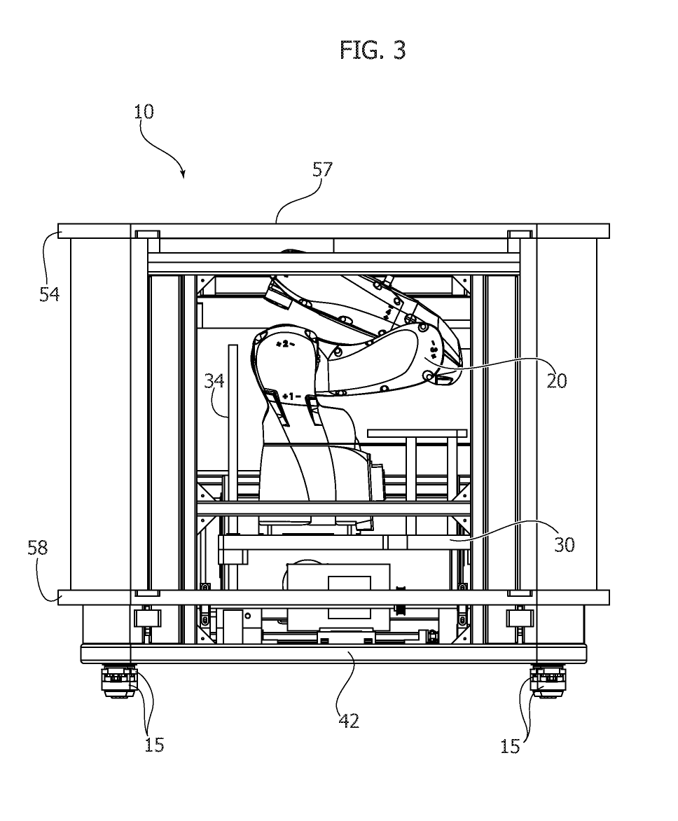

The motor 101 is designed to govern, through the jack 34, the movement of lowering and raising of the stand 30. This can in particular move between a position of minimum height (see FIG. 3), which corresponds to the aforementioned lowered position of the robot 20, and a position of maximum height (see FIGS. 4A and 4B), which corresponds to the aforementioned raised position of the robot. Appropriate end-of-travel elements of a mechanical, electrical, or else electromechanical type define these two end positions of the stand.

As may be seen in FIG. 1, the working surface P has a through opening P′, through which, from the stand 30, the robot projects above the working surface P and through which the robot passes when it moves into its lowered position. In this position, the robot 20 is entirely contained within the base 40. For its own part, the robot assumes, in this position, a completely contained condition so as to occupy as little space as possible and hence find sufficient space within the base, for its housing. The control unit of the cell may be configured for bringing the robot into this condition whenever it is set in an inoperative state. It should be noted that preferably—as envisaged in the embodiment illustrated—this robot is an articulated robot with at least four axes, which has at least three successive horizontal axes of articulation. This type of robot is in fact able to assume a completely collapsed position and is hence particularly suited to being used in the cell described herein.

With reference to the protective screen 50, in various preferred embodiments, as in the one illustrated, it has a frame comprising two main uprights 52, arranged symmetrically—with respect to a vertical plane orthogonal to the front side of the base—in a rear region of the working surface, and a cage structure, which is carried by these two uprights and encloses the working surface P. As will be seen in what follows, the two uprights 52 are carried by a vertical-movement system enclosed within the base 40.

The cage structure mentioned, carried by the two uprights 52, is constituted by a top horizontal frame 54, fixed, via brackets (not visible), to the top ends of the uprights 52, a series of vertical rods 56 that hang from the top frame, and a bottom frame 58 carried by the bottom ends of the rods 56 and having a shape substantially corresponding to that of the top frame 54.

The two frames 54 and 58 define in plan view a closed profile that is larger than the overall section of the base 40 and, in particular, that surrounds the aforesaid base so that the overall structure described will be free to slide without any risk of interference with respect to the base 40.

Mounted between the two frames 54 and 58 are a series of panels 55, preferably made of transparent plastic material, for example polycarbonate, which come to close totally, on all sides, the volume enclosed within the structure. Preferably, on the front side the screen 50 has two mobile panels, which can slide as in the example illustrated (see FIG. 1), or else swivel as in alternative embodiments, to enable access to the inside of the protective screen. Further panels 57 are mounted on the top frame 54 to define the roof of the screen 50.

With reference now to the system for movement of the screen 50, this comprises two lifting jacks 64, each associated to one of the two main uprights 52, and a series of guides 82 and 84.

With reference to the jacks 64, the internal-screw member (not illustrated) of each jack is fixed to the bottom end of the respective upright 52. The screw member is, instead, constrained between the supporting plates of the two top and bottom frames 42 and 46. At the bottom, the screw member terminates within a block 65 for transmission of motion, which is fixed on a plate of the base frame 42.

In various embodiments, as in the one illustrated (see in this connection FIG. 5), the transmission blocks 65 of the two jacks have on their output shaft respective pulleys 67 that are connected via a belt to two pulleys 73, 75 carried by one and the same horizontal shaft 72 constrained via supports, at portions thereof set at a distance apart from one another, to the plates of the bottom frame 42. This shaft has, in a position between the two pulleys 73, 75, a further pulley 77, which is in turn connected via a belt to a pulley 79 fitted on the output shaft of an electric motor 103. The motor 103 is also carried by a supporting plate of the bottom frame 42.

The motor 103 is designed to govern, through the two jacks 64, the movement of lowering and raising of the screen 50. As has been seen above, the latter can move between the lowered position illustrated in FIGS. 2 and 3 and the raised position of FIGS. 4A and 4B. Appropriate end-of-travel elements of a mechanical, electrical, or else electromechanical type define these end positions of the screen 50.

Associated to the two uprights 52 are two respective guides 82, which are preferably prismatic, designed to guide the movement of sliding of the uprights with respect to the base 40. The two vertical bars of the prismatic guide are mounted up against the two uprights 52 and are fixed at the bottom and at the top to the plates of the frames 42 and 46, respectively. The sliding blocks of the guides are fixed to the bottom ends of the two uprights 52.

Further guides, preferably of a cylindrical type, are, instead, associated to the front region of the screen 50. These envisage cylindrical rods 84 that are suspended on the top frame 54 of the screen 50 and engage guide bushings (not visible) carried by the supporting plates of the top frame 46 of the base 40. Possibly, further cylindrical guides may be associated, according to similar modalities, to the bottom frame 58 of the screen 50.

The cell 10 comprises a unit for controlling the movement of the protective screen 50 and of the robot 20. This movement may be activated by the operator through a control panel (not visible), which is preferably set on an outer side of the base 40, in a bottom region thereof that is readily accessible even when the protective screen 50 is in its lowered position and surrounds the base itself.

As may be seen in FIG. 1, applied on the frame of the base are outer coating panels that together define a casing within which the various means for driving and control of the cell are enclosed. In this connection, in addition to the means already referred to, moreover contained within the base are a unit for control of the robot (not visible) and an inverter assembly 105 for driving the two electric motors 101 and 103.

In various preferred embodiments, as in the one illustrated, the control unit is set within an extractable drawer 92 provided on the front side of the base. The base moreover envisages two further drawers 94, 96, provided on its opposite sides, first of which carries a portable control device of the robot (the so-called “teach pendant”), and the second of which is, instead, equipped for installation of devices for communication with the robotized system (robot cabin), for example HMIs, PLCs, mini computers (e.g., Raspberry, Arduino, etc.), electronic boards, electrical accessories, etc.

The drawer 94 is equipped with an ergonomic support for the teach pendant, which is height-adjustable and slightly inclined backwards so as to enable the operator to operate conveniently on the teach pendant, even leaving it resting on the support.

At the front, the base 40 moreover has an extractable shelf 98, designed to constitute an accessory resting surface, for example for carrying a laptop.

In various preferred embodiments, associated to the various drawers referred to, as also to the shelf, are electrical or electromechanical switches configured for changing their position, and the signals of these are used by the control unit of the cell for enabling movement of the protective screen only when the drawers and the shelf are in their closed configuration.

In various preferred embodiments, the cell 10 may moreover be equipped with a system for taking pictures in order to record what is occurring inside the cell during the demonstration activities, and the pictures taken may be displayed in real time on a separate display. This system and the display associated thereto increase accessibility to the cell and exploitation of the demonstration activities conducted therein, and may advantageously be used above all in the cases where the public that is present at the demonstration exceeds a certain number of people so that some could have a poor direct view. Preferably, the shooting system in question has at least one camera mounted in an overhead position on an inner side of the screen 50. The cell has a series of connectors for direct connection of the camera to an external display and possibly also for concomitant connection of the camera itself to a laptop.

Of course, without prejudice to the principle of the invention, the details of construction and the embodiments may vary, even significantly, with respect to what has been illustrated herein purely by way of non-limiting example, without thereby departing from the scope of the invention, as is defined by the annexed claims. In this connection, it should be noted that, instead of the screw jacks referred to above, it is possible to envisage jacks of some other type, for example fluid-operated jacks. Likewise, the types of guide used for guiding movement of the stand 30 and of the screen 50 may also vary from the ones indicated.

As anticipated above, the cell 10 may in any case envisage a vertical-movement system common for the robot 20 and the screen 50. With reference to the embodiment illustrated above, for example, the cell may present only the jacks 64 that drive the movement of the screen 50, and, in this case, the stand 30 is then fixedly constrained via brackets to the uprights 52 of the screen 50, so that also this can be moved by the jacks.

Finally, it should be noted that, instead of the jacks in question, it is also possible to envisage completely mechanical devices operating by way of counterweights.

1. A robot cell, in particular for demonstration purposes, of the type comprising:
a robot;
a base, which carries a unit for control of said robot and defines a working surface (P) where said robot operates; and
a protective screen configured for separating from outside said working surface and said robot (20) that operates on said working surface;
said robot cell being characterized in that:
said protective screen is carried by a first vertical-movement system and is vertically mobile between a raised position, in which it separates from outside said working surface and said robot that operates on said working surface, and a lowered position, in which it extends prevalently underneath said working surface; and
said robot is carried by a one of the first vertical-movement system or a second vertical-movement system and is vertically mobile between a raised position, in which said robot can operate on said working surface, and a lowered position, in which said robot is set underneath said working surface and is contained within said base.

2. The cell according to claim 1, wherein said protective screen is operable to selectively slide out of said base and wherein said lowered position surrounds said base.

3. The cell according to claim 1, wherein said protective screen further comprises at least one upright, which is carried by said first vertical-movement system, and a protective panel, which is carried by said upright and is free to slide out of said base.

4. The cell according to claim 1, wherein said protective screen further comprises:
a frame comprising at least one upright, which is carried by said first vertical-movement system, and;
a cage structure, which is carried by said upright and is operable to selectively slide out of said base.

5. The cell according to claim 4, wherein said cage structure comprises a top frame fixed to a top end of said upright, a bottom frame, and a series of rods, which connect said top frame to said bottom frame.

6. The cell according to claim 4, wherein said cage structure comprises a top frame and a plurality of rods, which hang from said top frame.

7. The cell according to claim 5, wherein said bottom frame has a closed profile circumference that is larger than the circumference of said base and surrounds said base remaining at a distance therefrom so as to be operable to slide with respect to said base.

8. The cell according to claim 1, wherein said robot is mounted on a stand carried by said one of the first or the second vertical-movement system.

9. The cell according to claim 1, wherein said first movement system comprises at least one lifting jack, at least one slide guide, and at least one electric motor.

10. The cell according to claim 1, comprising a unit for control of said first vertical-movement system.

11. The cell according to claim 10, further comprising at least one:
a first extractable drawer containing said unit for control of said robot;
a second extractable drawer containing a mobile device that can be manually gripped for control of said robot by the operator, wherein preferably said second drawer contains a support for said mobile device, which is inclined backwards and is height-adjustable; and
an extractable resting shelf.

12. The cell according to claim 1, further comprising at least one camera for taking pictures of the working surface of said cell.

13. The cell according to claim 1, wherein said working surface defines an orderly array of holes for fast installation of accessories on said working surface.

14. The cell according to claim 9, wherein said second vertical movement system comprises a lifting jack, at least one slide guide, and an electric motor.

15. A robot cell for use in visual demonstrations, the cell comprising:
a base having a working surface, the working surface defining a through opening;
at least one vertical movement device connected to the base;
a protective screen connected to the at least one vertical movement device, the at least one vertical movement device operable to selectively move the protective screen between a raised demonstration position surrounding the working surface and a lowered position below the working surface;
a stand connected to the at least one vertical movement device, the at least one vertical movement device operable to selectively move the stand between a raised demonstration position and a lowered position; and
a robot connected to the stand, wherein when the stand is in the raised demonstration position the robot extends through the through opening and above the working surface and when the stand is in the lowered position the robot is positioned below the working surface and within a periphery of the portable base.

16. The robot cell of claim 15 wherein the at least one vertical movement device comprises:
a first vertical movement device connected to the protective screen; and
a second vertical movement device connected to the stand.

17. The robot cell of claim 16 wherein each of the first and second vertical movement devices each further comprise:
a screw member;
an electric motor connected to the screw member, wherein on energizing of the electric motor, the screw member selectively moves the respective protective screen or the stand between the raised demonstration position and the lowered position, in the lowered position the respective protective screen and robot are positioned below the working surface.

18. The robot cell of claim 15 wherein the base further comprises an exterior closure panel defining an enclosed interior space within the base, wherein when the stand is positioned in the lowered position, the stand and the robot are completely concealed under the working surface and the base exterior panel within the enclosed interior space.

19. The robot cell of claim 15 wherein when the protective screen is in the lowered position, the screen is circumferentially positioned about the base in a compact orientation.
